(19) United States
(12) Patent Application Publication
(10) Pub. No.: US 2006/0197038 A1
(43) Pub. Date: Sep. 7, 2006

(54) Incoming sheet skew, lateral and process position detection with an angled transverse sensor array bar

(75) Inventors: Daniel C. Park, West Linn, OR (US); James B. Jensen, Woodburn, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/151,076

(22) Filed: Jun. 13, 2005

(51) Int. Cl. G01N 21/86

(52) U.S. Cl. 250/559.37

(57) ABSTRACT

Automatically providing electronic sheet orientation information by moving the sheets in a sheet path past a multiple photodetectors array bar to provide electrical signals corresponding to the initial sheet orientations, where this photodetectors array bar is angularly mounted at a transverse but non-perpendicular angle to the sheet path so that differently positioned subsets of photodetectors may be activated by the leading edge of the sheets at different sheet movement positions. These signals may be compared at different time intervals and appropriately electronically analyzed to provide sheet skew, process and lateral orientation information which may be used to automatically control an sheet registration correction system, such as for a printer.

Disclosed in the embodiments herein is an improved system for automatically accurately detecting the orientation, especially skew, of moving sheets (such as print media sheets moving in a paper path of a printer) with an elongated multiple photodetector array, such as a low cost imaging bar, oriented at a non-perpendicular angle transversely of the sheet path. Calculations made from electronic information from the photodetector array corresponding to the detection at different times and different positions on the photodetector array of different parts of the sheet, which may be sheet lead and/or trail edges, and/or sheet corners, may be used to control associated automatic sheet deskewing and/or registration systems which can provide partial sheet rotation and/or other sheet positional corrections in the sheet process direction and/or lateral direction.

By way of background, various types of print media sheet deskewing systems are known in the art. The following commonly owned patent disclosures are noted by way of some examples, and are incorporated by reference to the extent useful for background or other additional information or alternative apparatus, on so-called “TELER” or “ELER” sheet deskewing and/or side registration systems are U.S. Pat. No. 6,575,458, issued Jun. 10, 2003 by Lloyd A. Williams et al (U.S. Publication No. 20030020231, published Jan. 30, 2003) (Attorney Docket No. A1351); and U.S. patent application Ser. No. 10/237,362, filed Sep. 6, 2002 by Douglas K. Herrmann, (U.S. Publication No. 20040046313, published Mar. 11, 2004) (Attorney Docket No. A1602). Various “ELER” systems do only skew and process direction position correction, without sheet side shift lateral registration. The latter may be done separately or not at all. The present improvement is applicable to both and is not limited to either. In either ELER or TELER systems, initial or incoming sheet skew and position may be measured with a pair of lead edge sensors, and then two or more ELER or TELER drive rollers (having two independently driven, spaced apart, inboard and outboard nips) may be used to correct the skew and process direction position with an open loop control system in a known manner. Some ELER systems use one servomotor for process direction correction and another motor (e.g. a stepper motor) for the differential actuation for skew correction, as variously shown in Xerox Corp. U.S. Pat. Nos. 6,575,458 and 6,535,268 cited above. However, as shown in the cited art, there are also prior ELER systems with separate servo or stepper motors independently driving each of the two laterally spaced drive nips for process direction registration and sheet skew registration. The present improvement is also applicable to those systems.

There are other known types of sheet deskew systems, including what are now called “AGILE” systems. Some incorporated by reference examples are Xerox Corp. U.S. Pat. No. 6,173,952 B1, issued Jan. 16, 2001 to Paul N. Richards, et al (and art cited therein), U.S. Pat. No. 5,794,176, issued Aug. 11, 1998 to W. Milillo; U.S. Pat. No. 5,678,159, issued Oct. 14, 1997 to Lloyd A. Williams, et al; U.S. Pat. No. 4,971,304, issued Nov. 20, 1990 to Lofthus; U.S. Pat. No. 5,156,391, issued Oct. 20, 1992 to G. Roller; U.S. Pat. No. 5,078,384, issued Jan. 7, 1992 to S. Moore; U.S. Pat. No. 5,094,442, issued Mar. 10, 1992 to D. Kamprath, et al; U.S. Pat. No. 5,219,159, issued Jun. 15, 1993 to M. Malachowski, et al; U.S. Pat. No. 5,169,140, issued Dec. 8, 1992 to S. Wenthe; U.S. Pat. No. 5,278,624, issued Jan. 11, 1994 to D. Kamprath et al; and U.S. Pat. No. 5,697,608, issued Dec. 16, 1997 to V. Castelli, et al. Also, IBM U.S. Pat. No. 4,511,242, issued Apr. 16, 1985 to Ashbee, et al.

Various optical sheet lead edge and sheet side edge position detector sensors are known which may be utilized as initial sheet skew detection systems in such automatic sheet deskew and registration systems. Various of these are disclosed in the above incorporated references, and other references cited therein, such as the above-cited U.S. Pat. No. 5,678,159, issued Oct. 14, 1997 to Lloyd A. Williams, et al; and U.S. Pat. No. 5,697,608 to V. R. Castelli, et al.

Particularly noted is U.S. Pat. No. 5,887,996, issued Mar. 30, 1999 to V. R. Castelli, et al. This patent teaches a short lateral (perpendicular to the process direction) sensor array to measure lateral, process, and skew position. However, this sensor is not angled, and skew is measured along the side edge of the media rather than from the lead edge. A weakness of that method and system is that this skew information is not obtained until after the lead edge of the sheet has passed some distance in the process direction beyond this sensor, which may too late for the particular registration correction system.

A specific feature of the specific embodiment disclosed herein is to provide A sheet orientation detection method for automatically providing electronic sheet orientation information, comprising moving said sheets in a sheet path relative to a multiple photodetectors array bar to provide electrical signals from activations of subsets of said photodetectors of said multiple photodetectors array bar corresponding to the orientations of said sheets, said multiple photodetectors array bar being angularly mounted at a transverse non-perpendicular angle to said sheet path such that different said subsets of photodetectors of said array bar of multiple photodetectors are activated to provided electrical signals therefrom by the leading edge of said sheets at different sheet positions corresponding to different time intervals in said movement of said sheets in said sheet path relative to said angularly mounted multiple photodetectors array bar, so as to provide electrical signals from said activations of said subsets of photodetectors of said multiple photodetectors array bar providing information corresponding to the orientations of said sheets.

Further specific features disclosed in the embodiment herein, individually or in combination, include those wherein the sheet orientation detection method of claim 1 wherein the movement of at least one corner of said sheets relative to said angularly mounted multiple photodetectors array bar provides electrical signals from activations of respective said photodetectors of said multiple photodetectors array bar providing additional sheet orientation information; and/or wherein the movement of at least one corner of said sheets relative to said angularly mounted multiple photodetectors array bar provides electrical signals from activations of respective said photodetectors of said multiple photodetectors array bar provides sheet lateral position information; and/or wherein said electrical signals from said multiple photodetectors array bar from the leading edge of said sheets at different said sheet positions in said movement of said sheets in said sheet path are provided by sampling said electrical signals at spaced time intervals; an/or wherein said sheets are print media sheets moving substantially linearly in a portion of a printer paper path; and/or wherein said electrical signals from said activations of subsets of said photodetectors corresponding to the orientation of said sheets relative to said angularly mounted multiple photodetectors array bar are electronically processed to provide electronic sheet orientation information for a sheet registration correction system; and/or wherein said sheets are moving in said sheet path with a range of initial sheet orientation skew angles relative to said sheet path, and said multiple photodetectors array bar is mounted skewed relative to said sheet path by a greater skew angle than said range of initial sheet orientation sheet skew angles; and/or a sheet orientation detection system for automatically providing electronic sheet orientation information for sheets moving in a sheet path, comprising a multiple photodetectors array bar with an array of linearly closely positioned photodetectors providing electrical signals from respective said photodetectors in response to the presence of a portion of a sheet at said positions of said photodetectors, said multiple photodetectors array bar being angularly mounted at a transverse non-perpendicular angle to said sheet path so that differently positioned said photodetectors along said array bar may provide said electrical signals therefrom at different sheet positions, and an electronic controller system for reading said electrical signals from said photodetectors at spaced time intervals in said movement of said sheets in said sheet path relative to said angularly mounted multiple photodetectors array bar to obtain electrical signals from said activations of respective said photodetectors and to provide calculated information corresponding to the orientations of said sheets; and/or wherein said angularly mounted multiple photodetectors array bar extends sufficiently laterally of said sheet path to capture the movement of at least one corner of said sheets relative to said angularly mounted multiple photodetectors array bar to provide electrical signals from activations of respective said photodetectors thereof to said electronic controller system to provide calculated sheet lateral position information; and/or wherein said electrical signals from said multiple photodetectors array bar are generated from the leading edges of said sheets at different positions of said leading edges of said sheets relative to said multiple photodetectors array bar in said movement of said sheets in said sheet path, and wherein said electronic controller system samples said electrical signals at spaced time intervals to calculate the skew of said sheets; and/or wherein said sheets are print media sheets, and a sheet feeding system is moving said print media sheets substantially linearly at a substantially known velocity, and said sheet path is a portion of a printer paper path; and/or wherein said sheets are moving substantially linearly in said sheet path with a range of initial sheet orientation skew angles relative to said sheet path, and said multiple photodetectors array bar is mounted skewed relative to said sheet path by a greater skew angle than said range of initial sheet orientation skew angles.

The disclosed system may be operated and controlled by appropriate operation of conventional control systems. It is well known and preferable to program and execute imaging, printing, paper handling, and other control functions and logic with software instructions for conventional or general purpose microprocessors, as taught by numerous prior patents and commercial products. Such programming or software may, of course, vary depending on the particular functions, software type, and microprocessor or other computer system utilized, but will be available to, or readily programmable without undue experimentation from, functional descriptions, such as those provided herein, and/or prior knowledge of functions which are conventional, together with general knowledge in the software or computer arts. Alternatively, the disclosed control system or method may be implemented partially or fully in hardware, using standard logic circuits or single chip VLSI designs.

The term “reproduction apparatus” or “printer” as used herein broadly encompasses various printers, copiers or multifunction machines or systems, xerographic or otherwise, unless otherwise defined in a claim. The term “sheet” herein refers to a usually flimsy physical sheet of paper, plastic, or other suitable physical substrate for images, whether precut or web fed. A “copy sheet” may be abbreviated as a “copy” or called a “hardcopy.” A “print job” is normally a set of related sheets, usually one or more collated copy sets copied from a set of original document sheets or electronic document page images, from a particular user, or otherwise related.

As to specific components of the subject apparatus or methods, or alternatives, it will be appreciated that, as is normally the case, some such components are known per se in other apparatus or applications, which may be additionally or alternatively used herein, including those from art cited herein. For example, it will be appreciated by respective engineers and others that many of the particular component mountings, component actuations, or component drive systems illustrated herein are merely exemplary, and that the same novel motions and functions can be provided by many other known or readily available alternatives. All cited references, and their references, are incorporated by reference herein where appropriate for teachings of additional or alternative details, features, and/or technical background. What is well known to those skilled in the art need not be described herein.

Various of the above-mentioned and further features and advantages will be apparent to those skilled in the art from the specific apparatus and its various operations or methods described in the example below, including the drawing figures (which are approximately to scale) wherein:

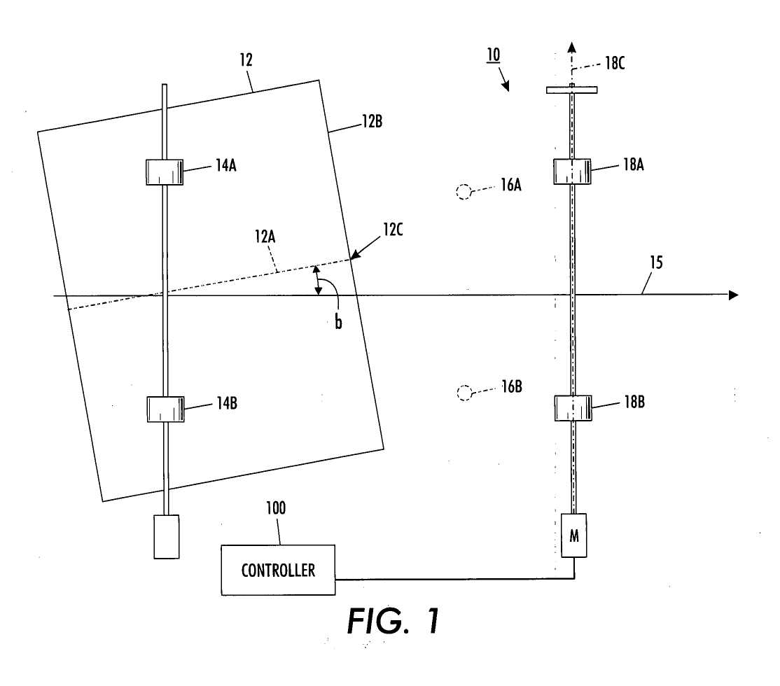

FIG. 1 is a schematic top view of one example of an exemplary sheet registration sensing system, showing an incoming skewed sheet position, being driven downstream in the process direction by a conventional fixed pair drive nip towards a conventional variable nips drive deskew and registration system, but with the subject registration sensor array bar not shown in this view for illustrative clarity;

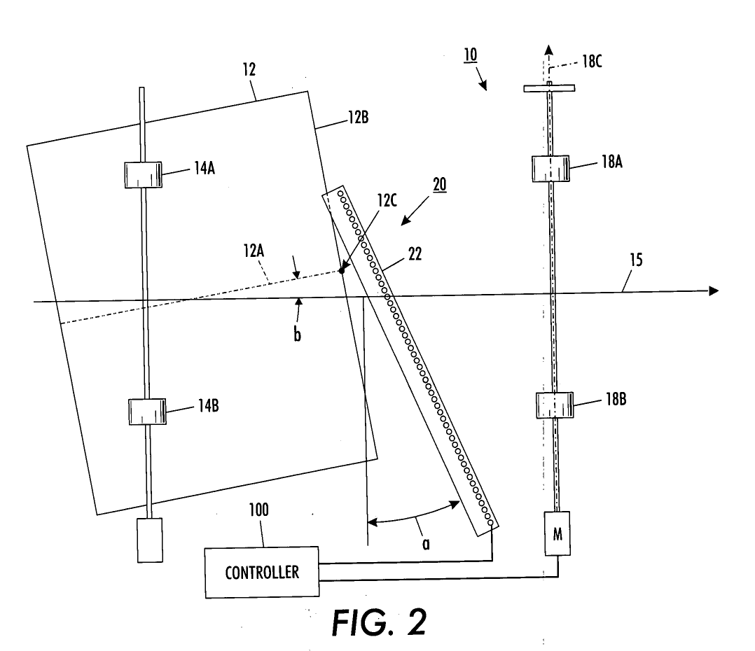

FIG. 2 is the same as FIG. 1 but further illustrates an exemplary position of an exemplary registration sensor array bar therein, with the moving sheet shown in a position relative thereto just before the sheet has been fed far enough in the process direction to cover and activate any of the photodetector pixels of this exemplary registration sensor array bar;

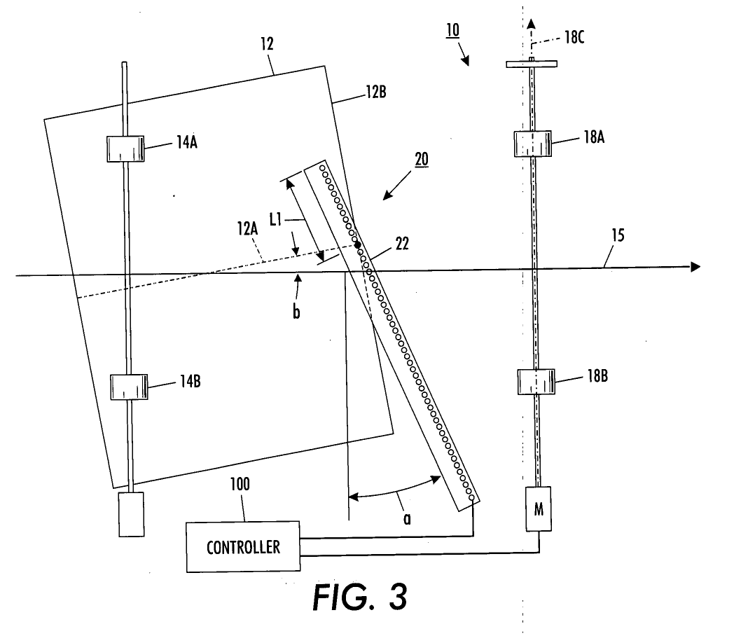

FIG. 3 is the same as FIG. 2 but with the sheet having been fed in the process direction a small further difference, that is further fed for a small known time period, in which further sheet position some of the upper pixels of the registration sensor array bar are now covered or underlaid and thus activated by the moving sheet;

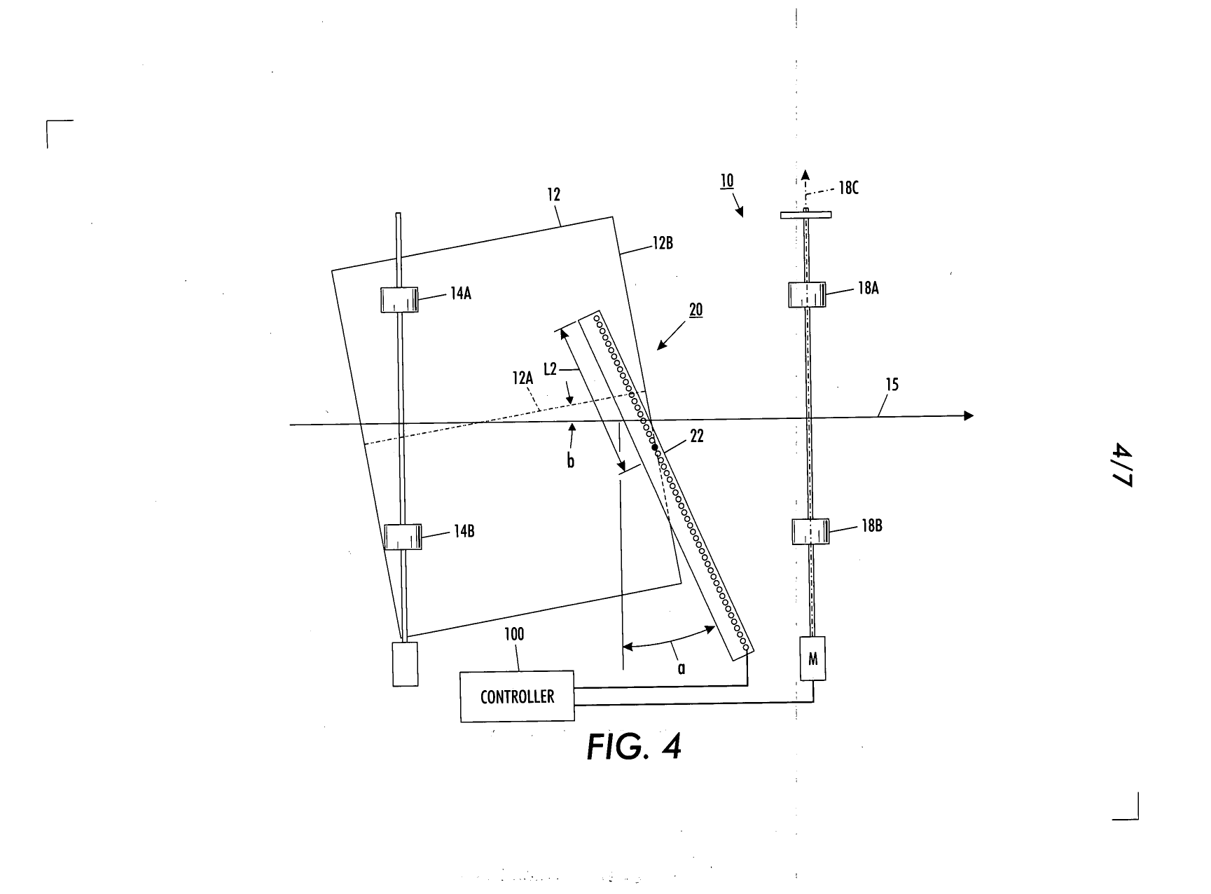

FIG. 4 is after second time interval later, with more pixels of the registration sensor array bar covered by that same moving sheet;

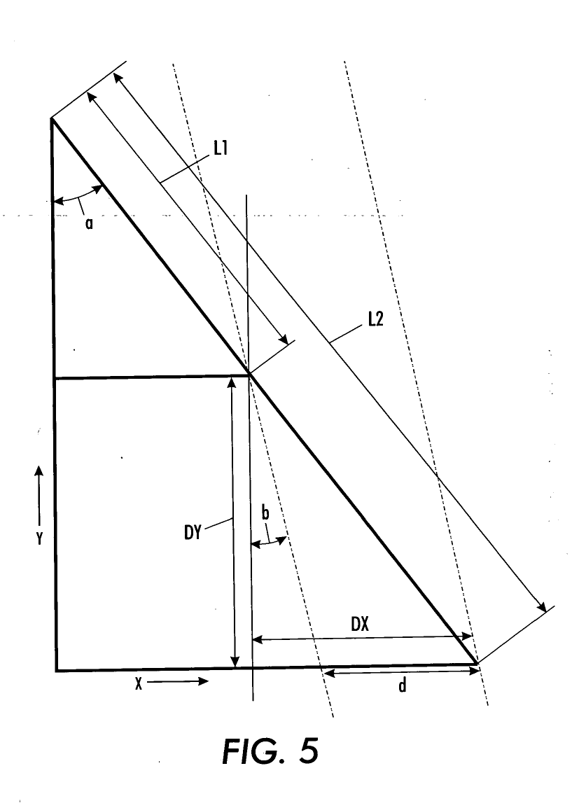

FIG. 5 is a corresponding geometric drawing for an exemplary skew calculation of said sheet in the sheet registration sensing system of FIGS. 1-4 with the electronic information from the different covered pixels of the registration sensor array bar at different times;

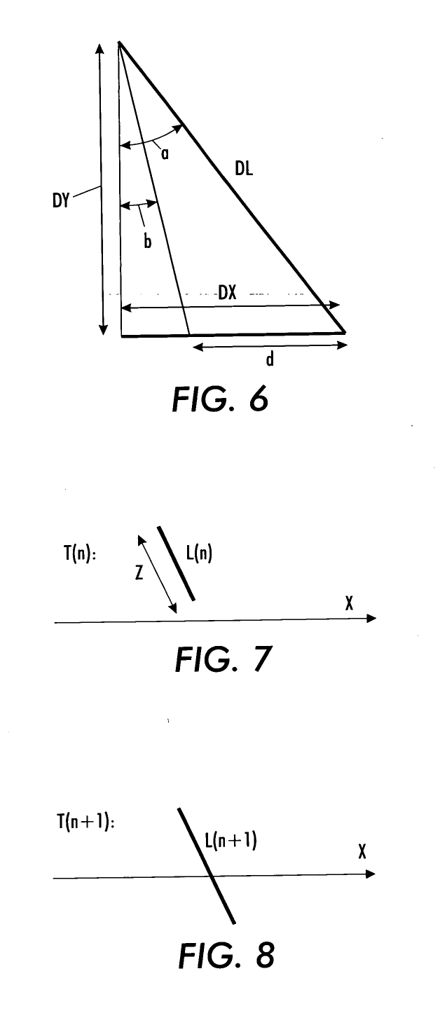

FIG. 6 is similar to FIG. 5, illustrating a further step in the sheet skew calculation;

FIGS. 7 and 8 are simplified geometric illustrations for an exemplary calculation of the sheet process position from the same electronic information from the different covered pixels of the registration sensor array bar at different times; and

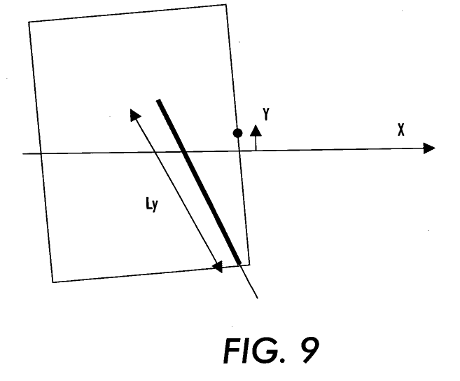

FIG. 9 is a simplified geometric illustration for an exemplary calculation of the sheet lateral position from the same electronic information from the different covered pixels of the registration sensor array bar at different times.

Describing now in further detail the exemplary embodiment with reference to the Figures, in FIGS. 2-4 there is shown one example of this sheet registration detection system 20 and its multiple pixels registration sensor array bar 22 and how it can be desirably readily incorporated into various sheet registration systems, such as that of FIG. 1.

FIG. 1 is a schematic top view of one conventional example of an exemplary sheet registration system 10, showing an incoming skewed sheet 12 position, as the sheet is being driven downstream in the paper path process direction by a conventional upstream fixed pair of sheet drive nips 14A, 14B, as shown by the process movement direction arrow 15. 15 is also the paper path centerline here. An exemplary entering sheet 12 skew angle “b” is showing the angle by which this particular sheet 12 is skewed away from the process direction 15, which of course may vary from sheet to sheet. This angle “b” here is illustratively exaggerated for illustrative clarity, as most incoming sheets in most printing systems would have a much smaller initial skew harder to measure accurately. The sheet 12 centerline 12A is shown here as a phantom line extending to the sheet lead edge 12B center point 12C. The sheet 12 here is being driven downstream in the process direction 15 towards a conventional downstream pair of relatively variable speed sheet feeding nips 18A, 18B, which are providing in this example (with the motor or motors M and controller 100) the registration system 10 for sheet deskew and process direction registration, as more fully and variously described in the above-incorporated patent examples. The TELER patent examples also show that lateral sheet registration can also be provided by the system 10 by compensating lateral shifting of both nips 18A and 18B in the lateral movement direction 18C. However, in such an exemplary prior art registration system 10, two laterally spaced individual sensors such as 16A, 16B shown here in phantom would be typical for measuring incoming sheet skew at only two points on the sheet lead edge, and as discussed above a separate lateral sheet position sensor is normally required. The exemplary registration sensor array bar 22 discussed further herein is not shown in FIG. 1 for illustrative clarity purposes.

By way of further background, as taught in the above-cited and other art, to execute most print media sheet registration methods and apparatus controls, accurate prior knowledge is needed of an initial media (incoming sheet) position or orientation in some, or all, of the process, lateral, and skew directions. As noted above, a traditional strategy for determining such incoming (or in-process) sheet positions has utilized two different sets and locations of sensors. A pair of point (small area) sheet edge sensors separated a known distance apart in the lateral direction is commonly used to detect incoming sheet skew and process direction position, such as 16A, 16B above. The amount of incoming sheet skew “b” can be calculated from the difference between the sensor 16A, 16B actuation times, the respective times when the sheet lead edge 12C crosses each respective sensor 16A, 16B. The process direction (paper path movement direction) position of the sheet lead edge 12C may be calculated from the average of these two lead edge sensor 16A, 16B actuation times. In addition, a separate transverse linear multiple sensors array (perpendicular to part of the paper path, at one side thereof) may be used to for sheet side edge detection to determine the lateral initial position of the sheet. This lateral position sensor may be pre-positioned in the nominal incoming media side edge position to cover the anticipated incoming sheets lateral position error range, or may be long enough to cover the side edge range variability range for all medias to be fed (which is much easier for a side-registered sheet path than for a center-registration sheet feed path handling sheets of different widths).

In contrast, the system 20 and method of this embodiment can utilize a single stationary linear multiple sensors array 22 to measure media process, lateral, and skew positions. If the sensor array 22 is wider than the media, it may also measure the sheet dimensions. If the sensor array 22 is wide enough to span one lateral edge of all media widths, it does not require any repositioning of that angled sensor array 22 even for a center-registered rather than a side-registered sheet path. A shorter bar may be used without repositioning in a side registration sheet path. In either case, enough of the bar 22 will be exposed to the lead edge of the media to gather at least two partial snapshots of the lead edge as described in the calculations below.

The disclosed embodiment may desirably utilize existing low cost mass produced commercially available imaging bars. That is, full document width color imaging (image sensor) bars such as those used in document scanners and/or discussed in the below incorporated cited patents and elsewhere. Such imaging bars are already commercially available in lengths long enough for at least short edge fed full width array scanning of various document widths for digital image scanning thereof. Thus, they are available in lengths sufficient to extent across the usable paper path sufficiently for registration edge detection of various different standard media widths, since the slight angle thereof here does not significantly change their dimension transverse the paper path. However, as noted, the array bar 22 as used herein does not need to be a full width array, allowing the use of a bar intended for short edge feed in a long edge feed media path, and also allowing the use of medias with a short edge that is wider than the array. As show in the example of the drawings and the calculations below, an imaging bar 22 being used as a sheet lead edge skew and other registration indicia detector does not need to extend fully across the paper path or the full width of the sheet 12. In a center registered paper path system (as shown in this example) the angled bar 22 may only extend from one maximum sheet size lateral edge position to substantially beyond the same side lateral edge of a minimum width sheet.

However, the embodiment disclosed herein may use such an existing low cost full width array imaging bar made from plural shorter bonded image bar chips having light detectors. Some examples of patents relating to such semiconductor color or monochrome imager bars or segments thereof and their operation or circuitry include incorporated by reference U.S. Pat. Nos. 5,859,421; 6,166,832; and 6,181,442. As noted in such patents and elsewhere, such imaging bars may be constructed from multiple abutted individual chips, each having multiple very small and closely spaced photo-sites. Data may be collected from these many imaging bar cells, pixels, or photo-sites (these terms may be used interchangeably herein) as to whether an illuminated target is detected or not. However, in this case, that electronic information is used instead for sheet edge position detection. The signals may be used digitally or in analogue form. The latter might be used for example to increase the sensing latitude for sheets at different distances from the photocells by providing more that just binary information. Also, illumination from the three different colored light sources of such imaging bars may be combined or used selectively.

Noted merely by way of further background are Xerox Corporation U.S. Pat. No. 5,808,297, issued Sep. 15, 1998; U.S. Pat. No. 5,543,838, issued Aug. 6, 1996; U.S. Pat. No. 5,550,653, issued Aug. 27, 1996; U.S. Pat. No. 5,604,362, issued Feb. 18, 1997; and U.S. Pat. No. 5,519,514, issued May 21, 1996. One spectrophotometer application is Xerox Corp. U.S. Pat. No. 6,621,576 B2 issued Sep. 16, 2003 to Jagdish C. Tandon and Lingappa K. Mestha, entitled “Color Imager Bar Based Spectrophotometer For Color Printer Color Control System.”

In the present system embodiment 20 this data may be collected in two or more “snapshots” from the imaging bar 22 output signals of a known time difference apart during the time period in which any part of the lead (and/or trailing) edge 12B of the sheet 12 is detected over any part of the imaging bar. Such as is show here by the difference in sheet 12 positions between FIGS. 3 and 4. This provides a substantial number of photo-site (pixel) signals from known bar 22 locations with a substantial pixel count and large pixel locations differences between these snapshots” or “time stamps” (due to the high DPI of the bar 22). From this electronic information both the sheet skew angle or orientation and sheet process direction position can be directly electronically calculated, such as by the examples provided below and in FIGS. 5 and 6.

However, the present embodiment is not necessarily limited to using such color imaging bars 22. It may be able to utilize even lower resolution and lower cost commercially available black and white facsimile document scanning bars. Or perhaps even partially defective (manufacturing reject) imaging bars with some defective pixels. This is not a document imaging system.

Importantly, the sensor array bar 22 is angled away from the lateral direction, at least slightly, desirably by substantially more of an angle “a” than the lead edge angle “b” of any anticipated incoming sheet skew. That is, this registration sensor array bar 22 is not conventionally mounted perpendicular to the process direction 15 like all of the above-described sheet registration sensors. For example, providing an angle “a” of 50 mrad (0.050 radians). This angle “a” is not critical, but is a known angle.

This transversely extending but angled sensor array 22 is not just measuring sheet lateral displacement like the above-cited transverse sensor arrays. In particular, sheet skew is being detected and calculated. This may be done in this case by comparing the length of the sensor array, e.g., the variable multiple numbers of sensor pixels of the angled sensor array that are covered that by variously skewed media between consecutive timed readings thereof when the lead edge of the media is crossing this angled sensor array. Thus, even small angles of sheet skew (substantially perpendicular sheet lead or trail edges) can be measured accurately. Process position may be determined by interpolating time stamps of sensor readings to calculate when the lead edge of the media crossed the intersection of the media centerline and the sensor axis. Lateral position may be calculated using the length of sensor covered immediately after the lead edge crosses the sensor.

Turning now to the drawings and to a specific example of a specific printer, assume a printer with a print media width that ranges from 105 mm to 320 mm, with a maximum media velocity of 0.5 meters per second. Assume that the worst incoming media mis-registration is 7 mm maximum lateral mis-registration and 25 milliradians of maximum sheet skew angle “b.” Assume that the multiple photodetector sensor array bar 22 in this example is a 600 dpi contact imaging sensor (CIS) with a length of 216 mm, which outputs a stream of analog outputs for each pixel to complete one line reading, and that a line reading can be completed every 1.5 ms. Assume that with this bar 22 length and a 50 mrad angle of bar 22 from transverse the paper path or process direction that for this particular paper path the outer bar end extends transversely 51 mm beyond the centerline 15 (less than the sheet 12 dimension on that side of the centerline 15) and the rest of the bar extends 165 mm on the inside of the centerline 15.

Turning now to FIGS. 5 and 6, the term definitions and the following calculations are:
A=sensor skew angle
b=lead edge media skew angle
L1=length of covered pixels at time T1
L2=length of covered pixels at time T2
V=average process direction velocity of the lead edge
X=process direction
Y=transverse direction
V=average process direction velocity of sheet lead edge
DL=L2−L1
DY=change in length of covered pixels reflected to the y axis
DX=change in length of covered pixels reflected to the x axis

Dt=T2−T1 [The difference between the two different sheet lead edge 12B “snapshot” times at the positions of FIGS. 3 and 4, for example, which is also shown by the difference between the two dashed lines in FIG. 5.]

d=process direction distance covered in Dt
d=V*Dt

For a Skew Position Calculation for FIG. 6:

Create a relation for “b” in terms of “a” and DL:
DX=d+DY*tan(b)=DL*sin(a)

For small angles of a and b, the above can be simplified to:
d+DY*b=DL*a

Determine DY:
DY=DL*cos a

Since a is small (for a=50 mrad, cos a=0.999):
DY=DL

So now:
d+DL*b=DL*a
b=(DL*a−d)/DL
b=a−d/DL
b=a−V*Dt/DL

Skew Position Examples Calculations regarding FIG. 6, assuming:
b=a−V*Dt/DL
V=1.0 mm/ms
Dt=1.5 ms
a=0.050 radians
DL=50 mm: b=0.025 radians
DL=30 mm: b=0.000 radians
DL=20 mm: b=−0.025 radians

A Process Position Calculation for FIGS. 7 and 8:

The sheets process position may be calculated as the time at which the sheet lead edge crosses the intersection of the sensor array and the media path center.

Term definitions:

Tp=process position time

T(n)=time of measurement just before lead edge crosses intersection

T(n+1)=time of measurement just after lead edge crosses intersection

Z=length of sensor beyond X-axis.

FIG. 8:

Linearly interpolating:
Tp=[(Z−L(n))*T(n+1)+(L(n+1)−Z)*T(n)]/[L(n+1)−L(n)]

Lateral Position Calculation for FIG. 9:

The sheet lateral position “Y” [which may be used, for example, to control the lateral movement 18C of the sheet registration system 10] may be calculated directly off the side edge of the sheet immediately after the lead edge completely crosses the sensor bar 22.

DL may be monitored to determine when the lead edge finishes crossing the sensor bar:

DL(min) for lead edge=20 mm (1 m/s, Dt=1.5 ms)

DL(max) for side edge=0.04 mm

(So the change in DL should be easy to distinguish.)

Ly=length of sensor covered immediately after the change in DL is detected

W=the media width

So:
Y=W/2−cosine(a)*(Ly−Z)

The sheet process position information obtained by any or all of the above calculations, or alternatives thereof, may be used to correct the sheet process position to a desired position by accelerating or decelerating the sheet in the nips 18A, 18B of the registration system 10, or deskewing and/or laterally registering the sheet with any of the other registration systems noted above

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A sheet orientation measurement system for automatically providing electronic sheet skew and other sheet orientation information for print media sheets moving in a sheet path from the moving lead edges of said print media sheets, wherein said print media sheets are moving substantially linearly at a known velocity in said sheet path with a limited range of initial sheet skew angles relative to said moving sheets sheet path, said sheet orientation measurement system further comprising:
a photodetectors array bar mounted skewed relative to said moving sheets sheet path by a skew angle greater than said limited range of initial sheet skew angles, said photodetectors array bar having a substantially linear array of a multiplicity of closely positioned photodetectors extending transversely over a substantial transverse portion of said moving sheets sheet path providing electrical signals from differently positioned subsets of said multiple photodetectors along said photodetectors array bar which are detecting at least a portion of a said moving sheet lead edge relative to said photodetectors array bar at at least two spaced apart time intervals, said subsets of said photodetectors along said photodetectors array bar providing different electrical signals therefrom at at least two different said sheet lead edge positions of said moving sheet lead edge relative to said photodetectors array bar at said at least two spaced apart time intervals, and
an electronic sheet orientation calculation system operatively connected to said photodetectors array bar to receive said different electrical signals from said photodetectors array bar,
said electronic sheet orientation calculation system reading said different electrical signals from said different subsets of said multiple photodetectors at said at least two different spaced apart time intervals in the movement of a single said sheet moving in said sheet path relative to said photodetectors array bar, and calculating therefrom the skew and at least one other orientation of said sheet in said sheet path.

14. The sheet orientation measurement system of claim 13 wherein said photodetectors array bar extends beyond at least one maximum transverse dimension of said print media sheets moving in said sheet path to detect with said photodetectors thereof at least one corner of said sheet moving in said sheet path, and wherein said electronic sheet orientation calculation system can additionally calculate therefrom the transverse lateral position of said sheet in said sheet path.

15. The sheet orientation measurement system of claim 13 wherein said photodetectors array bar extends beyond both maximum transverse dimensions of said print media sheets moving in said sheet path, wherein said electronic sheet orientation calculation system can additionally calculate therefrom the transverse dimensions of said sheets.

16. A sheet orientation measurement method for automatically providing electronic sheet skew and other sheet orientation information for print media sheets moving in a sheet path from the moving lead edges of said print media sheets, wherein said print media sheets are moving substantially linearly at a known velocity in said sheet path, wherein a photodetectors array bar is mounted skewed relative to said moving sheets sheet path, said photodetectors array bar having an extending linear array of a multiplicity of closely positioned photodetectors extending transversely over a substantial transverse portion of said moving sheets sheet path, comprising:
providing different electrical signals from different subsets of said multiple photodetectors extending along said photodetectors array bar detecting at least a portion of a said moving sheet lead edge relative to said photodetectors array bar at at least two different spaced apart time intervals,
said at least two different spaced apart time intervals corresponding to at least two different spaced apart said sheet lead edge positions of a single moving sheet lead edge relative to said photodetectors array bar, and
performing an electronic sheet orientation calculation from said different electrical signals from said photodetectors array bar from said different subsets of said multiple photodetectors at said at least two different spaced apart time intervals in the movement of said single sheet in said sheet path relative to said photodetectors array bar by calculating therefrom the skew and at least one other orientation of said single sheet,
and repeating said electronic sheet orientation calculation for subsequent said sheets moving in said sheet path with said different electronic signals from said photodetectors array bar at additional said spaced apart time intervals.

17. The sheet orientation measurement system of claim 16 further including detecting a sheet corner with said photodetectors array bar and calculating the lateral position of said sheet in said sheet path therefrom.

18. The sheet orientation measurement method of claim 16, wherein said at least one other calculated orientation of said sheet is the position of said lead edge of said sheet relative to said photodetectors array bar in said movement direction of said sheets in said sheet path.
